(19) United States
(12) Patent Application Publication
(10) Pub. No.: US 2019/0275867 A1
(43) Pub. Date: Sep. 12, 2019

(54) DEVICE FOR OPERATING A SYSTEM FOR COVERING AN OPENING AND COVERING UNIT USING SUCH A DEVICE

(71) Applicant: FLEXOMA, BRIGNAIS (FR)

(72) Inventor: Aymeric PATIN, MARENNES (FR)

(21) Appl. No.: 16/348,903

(22) PCT Filed: Nov. 3, 2017
(86) PCT No.: PCT/FR2017/053012

§ 371 Date: May 10, 2019

(30) Foreign Application Priority Data
Nov. 10, 2016 (FR) 1660930

(51) Int. Cl. B60J 1/20; E06B 9/68

(52) U.S. Cl. CPC B60J 1/2027; B60J 1/2066; E06B 9/68

(57) ABSTRACT

Disclosed is a device for operating a system for covering an opening, including a movable end moving between retracted and extended positions in which the system covers at least part of the opening. The device includes: a flexible push strip with first and second ends, connecting, close to the first end, to the movable end of the covering system; a motor driving the push strip, moving the first end between proximal and distal positions. The push strip transmits a push force to the movable end of the covering system. The device also includes two parallel guide rails on top of or facing one another, in which first and second ends of the push strip travel. The drive includes a drive and idler wheel around which the push strip winds, so the push strip is partly in the first guide rail and partly in the second guide rail.

### BACKGROUND OF THE INVENTION

### Field of the invention

The present invention relates to the technical field of operating devices for a window blind system, in particular for a vehicle window, or also a building window blind system.

### Description of the Related Art

In the above-mentioned field, it is known, in particular for the motorized operation of building window blind curtains, operating devices implementing a belt that circulates between a drive gear and a steering pulley and that is connected to a carriage integral with the curtain. The drive gear is then driven by an electrical motor reducer associated with control means for controlling the rotation of the motor reducer in one direction for opening the curtain and in the opposite direction for closing the latter. Such operating devices effectively allow a motorized opening or closing of the curtain but have the drawback to implement a steering pulley that is liable to make the device implantation difficult and to increase the bulk thereof. Moreover, using a belt induces a relatively significant total bulk insofar as it is advisable to provide the necessary spaces for the forward strand and the return strand of the belt, as well as for the steering pulley.

In order to remedy these drawbacks, the applications DE20309690, EP2098676 and EP1967400 have proposed devices for operating a window blind system that comprises at least one end mobile in translation between a retracted position and an extended position in which the system blinds at least in part the window. According to these documents, the operating devices further comprise:
a flexible push belt that comprises a first and a second ends and that is intended to be linked near or at its first end to the mobile end of the blind system,
motorized means for driving the push belt, adapted to translationally move the first end between a proximal end corresponding to the retracted position of the blind system and a distal position corresponding to the extended position of the blind system,
the push belt being adapted to transmit a pushing force to the mobile end of the blind system. Still according to these documents, when the blind system is open, the push belt is stored in an ad-hoc housing by being wound on itself.

Now, such a storage of the push belt is relatively cumbersome, taking into account the volume occupied by the push belt wound on itself, which represents a certain difficulty for integrating the operating device in cramped places such as, in particular, the passenger compartments of vehicles.

### SUMMARY OF THE INVENTION

In order to remedy this drawback, the invention relates to an operating device of a window blind system that comprises at least one end mobile in translation between a retracted position and an extended position in which the system blinds at least in part the window, the operating device comprising:
a flexible push belt that comprises a first and a second ends, which is intended to be connected to the mobile end of the blind system and which is adapted to transmit a pushing force to the mobile end of the blind system,
motorized means for driving the push belt, adapted to translationally move the push belt between a proximal position corresponding to the retracted position of the blind system and a distal position corresponding to the extended position of the blind system.

According to the invention, the operating device is characterized in that it comprises two parallel tracks or slides, superimposed to each other or facing each other, in which the first and second ends of the push belt circulate, and in that the drive means comprise a drive and steering wheel around which the push belt is partially wound so that a portion of the push belt is located in the first slide and another portion is located in the second slide.

Implementing two parallel slides, superimposed to each other or facing each other, allows storing the push belt in a compact manner and in a volume of small thickness, whatever the position of the device insofar as a strand of the push belt is always located in a slide, whereas the other strand of the push belt is located in the other slide. Hence, according to the movements of the operating device, the push belt performs an alternating movement between the two slides by being partially wound around the drive and steering wheel. In addition to ensuring the transfer of the push belt from one slide to the other, this partial winding allows the transmission to the push belt of greater forces than those allowed by the prior art devices. Moreover, by avoiding the winding, the invention allows using the two stands or ends of the push belt. Hence, one strand or one end of the push belt can operate the blind system, whereas the other strand is used in association with a sensor to define an end of travel or to determine the position of the blind system. The other strand may also be used to operate a second blind system.

With this objective of optimum force transmission and according to a feature of the invention, the push belt surrounds the drive and steering wheel over an angular sector comprised between 170° and 340°, and preferably comprised between 180° and 340°.

According to another feature of the invention, the push belt is not rigidly fastened to the blind system, except possibly at its connection with the mobile end of the blind system. It is to be understood by “the push belt is not rigidly fastened to the blind system” that the push belt is not integral with the blind system. Hence, in the case where the blind system comprises a curtain, according to this feature, the push belt is not integrated to said curtain.

According to a feature of the invention, the push belt is perforated and the drive means comprise a teethed drive wheel whose teeth mesh or cooperate with the perforations of the push belt so as to exert a pushing force to the latter. Such an embodiment provides a simple way of transmitting the significant forces to the push belt and hence to the mobile end of the blind system.

According to another feature of the invention, the operating device comprises a profile that carries and delimits at least in part the parallel guiding tracks facing each other. The implementation of such a profile allows perfectly controlling the bulkiness of the device while facilitating the installation of the latter.

According to a first embodiment of this feature, the profile is generally U-shaped with two parallel legs connected by a web, each leg delimiting a guiding track for one end of the push belt.

According to a feature of the invention, the device comprises at least one connection carriage between the push belt and the blind system.

According to a variant of this feature and of the first embodiment, the carriage is located at least in part between the two parallel legs of the profile and moves between these latter.

According to another variant of this feature, the carriage is adapted to be reversibly or removably connected to the blind system. This removable character allows separating the blind system from the operating device so as to allow, for example, a manual operation of the blind system.

According to another variant of this embodiment, the bottoms of the two guiding tracks facing each other are located at a distance lower than or equal to the diameter of the guiding and steering wheel.

According to a feature of the invention, the device comprises a casing that surrounds the drive and steering wheel and that delimits a drive chamber inside which is located the drive wheel and whose peripheral wall guides the push belt. The implementation of such a casing allows facilitating the installation of the drive device while guarantying a great safety of operation. Moreover, the guiding performed by the peripheral wall of the drive chamber allows a perfect transmission of the forces to the push belt while preventing the latter from getting out of the drive and steering wheel or to go too far away from the latter. The guiding also allows reducing the diameter of the drive wheel while allowing the transmission of significant forces insofar as the peripheral wall prevents the push belt from “flying back” or escaping from the drive wheel.

According to a variant of this feature, the casing delimits at the exit of the drive chamber two portions of the guiding tracks that are curved and connected to the guiding track portions delimited by a rectilinear profile that delimits two parallel tracks or slides for guiding the two opposite strands of the push belt.

According to a feature of the invention, the operating device comprises a guide with a median longitudinal wall, a first face of which delimits at least in part a first slide in which the first end of the push belt moves and a second face of which, opposite to the first one, delimits at least in part a second slide in which the second end of the push belt circulates, and the drive means comprise a steering wheel around which the push belt is partially wound so that a portion of the push belt is located in the first slide and another portion is located in the second slide. This feature makes it possible to make a particularly compact operating device insofar as it is not necessary to store the push belt wound on itself.

According to another feature of the invention, the push belt has a thickness lower than or equal to 3.0 mm, preferably lower than or equal to 0.5 mm, and in a more preferably lower than or equal to 0.2 mm. The implementation of a push belt having such dimensions makes it possible to obtain an operating device having a reduced bulk in the areas of rectilinear displacement of the push belt.

According to still another feature of the invention, the push belt is made at least in part of spring steel. The use of such a material makes is possible to obtain a push belt of low thickness having, on the one hand, a sufficient stiffness for transmitting the forces and, on the other hand, a flexibility allowing a folding of the push belt over itself or also a winding of said push belt on itself.

According to a variant of this feature, the push belt is made at least in part:
of carbon spring steel, preferably of grades C67S+QT or C75S+QT or C85S+QT or C100S+QT or of reference 1.1204 or 1.1231 or 1.1248 or 1.1269 or 1.1274
or of stainless spring steel, preferably of grade X10CrNr18-8 or reference 1.4310.

According to the invention, the push belt may also be made of a composite material or as a complex of different materials, or also as a complex of several sheets or strips of a same material.

According to a preferred embodiment of the invention, the push belt is made of plastic material, such as polypropylene (PP).

The invention also relates to a window blind arrangement comprising:
a window blind system that comprises at least one first end mobile in translation between a retracted position and an extended position in which the system blinds at least in part the window,
and a first operating device according to the invention, whose push belt is connected to the first mobile end of the blind system.

According to a feature of the invention, the arrangement comprises:
at least one first load bar that it integral with the first mobile end of the blind system, which is connected to the push belt of the first operating device and which extends between two guiding rails,
and a system of crossed cables adapted to guarantee the perpendicularity of the first load bar (3) with respect to the guiding rails.

By system of crossed cables, it is to be understood a system of two cables in which the ends of each cable are fixed and rigidly fastened to two opposite points on a diagonal of the window. Each cable further passes within the load bar, which can slide on the cables. These latter have a length substantially equal to the sum of the length of the load bar and of the distance separating the fixed points of said cable measured parallel to the direction of displacement of the load bar.

According to a feature of the arrangement according to the invention, the blind system comprises a second end mobile in translation between a first position and a second position and the arrangement comprises a second operating device according to the invention whose push belt is connected to the second mobile end of the blind system. The implementation of a blind system with two mobile ends each associated with an operating device according to the invention allows obtaining different configurations of partial blinding of the window as a function of the users' needs.

According to a variant of this feature, the arrangement comprises:
at least one second load bar that is integral with the second mobile end of the blind system, which is connected to the push belt of the second operating device and which extends between two guiding rails,
and a system of crossed cables adapted to guarantee the perpendicularity of the second load bar with respect to the guiding rails.

According to another feature of the invention, the arrangement comprises a second blind system that comprises an end mobile in translation between a retracted position and an extended position in which the second system blinds at least in part the window, the mobile end of the second blind system being connected to the push belt of the first operating device, so that a rotation in one direction of the drive and steering wheel causes the mobile ends of the two blind system to get closer to each other and a rotation in the reverse direction causes the mobile ends to get away from each other. The implementation of two blind systems that are adapted to extend from two opposite ends allows dividing by two the closing and opening times, and also motorizing the two half-curtains with a single motorization device.

According to a variant of this feature, the arrangement comprises:
for each blind system, a load bar that is integral with the corresponding mobile end, which is connected to the push belt of the operating device and which extends between two guiding rails,
and a system of crossed cables adapted to guarantee the perpendicularity of the load bars (3) with respect to the guiding rails.

Of course, the different features, variants and embodiments of the invention may be associated with each other according to various combinations, insofar as they are not incompatible or exclusive from each other.

### BRIEF DESCRIPTION OF THE DRAWINGS

Moreover, various other features of the invention depart from the appended description made with reference to the drawings that illustrate non-limitative embodiments of an operating device for a blind system according to the invention.

FIG. 1 is an overall view of a window blind arrangement implementing an operating device according to the invention,

FIG. 2 is a partial perspective view showing a construction detail of the arrangement illustrated in FIG. 1,

FIG. 2′ is a flow diagram of a system of crossed cables providing the guiding of the load bar and the perpendicularity thereof with respect to the push belt,

FIG. 3 is a schematic cross-sectional view according to line III-III of FIG. 1,

FIGS. 4 and 5 are partial, schematic, perspective views showing in particular the drive means of the operating system illustrated in FIG. 1,

FIGS. 6 and 7 are schematic cross-sectional views showing construction details of the operating device shown in FIG. 1,

FIG. 8 is a transverse cross-sectional view of a profile defining two tracks for guiding the two strands of the push belt, on either side of the drive and steering wheel,

FIG. 9 is a cut-away, schematic, perspective view showing an example of implementation of the profile according to FIG. 9, at the steering of the push belt about the drive wheel,

FIG. 10 is a cut-away perspective view of construction details of a blind arrangement according to the invention implementing the profile illustrated in FIG. 8,

FIG. 11 is a partial top view of an embodiment of the motorization means of the operating device according to the invention,

FIG. 12 is a partial left view of the motorization means illustrated in FIG. 11,

FIG. 13 is a schematic perspective view of the motorization means illustrated in FIGS. 11 and 12,

FIGS. 14 and 15 are schematic views of an embodiment of a blind arrangement according to the invention, whose blind system comprises two mobile ends,

FIG. 16 is a schematic view of a system of crossed cables implemented in the arrangement illustrated in FIGS. 14 and 15,

FIG. 17 is a schematic, front elevation view of a blind arrangement comprising two horizontal-displacement blind systems,

FIG. 18 is a partially cut-away perspective view showing the connection of the two blind systems with the push belt of the associated operating device,

FIG. 19 is a schematic view of a window blind arrangement of trapezoidal shape,

FIG. 20 is a larger scale view of a construction detail of the arrangement illustrated in FIG. 19.

### DESCRIPTION OF THE PREFERRED EMBODIMENTS

It is to be noted that, in these figures, the structural and/or functional elements common to the different variants or embodiments may have the same references.

The invention aims to propose means allowing the motorized operation of a system S for blinding a window B, for example of a building or a vehicle, glazed or not, symbolized by chain dotted lines in FIG. 1. According to the illustrated example, the blind system S comprises a curtain 1 having at least one end 2 mobile between a retracted position R and an extended position E in which the system S blinds at least in part the window B. The curtain 1 comprises, opposite the mobile end 2, a fixed end 2′. In the present case, the mobile end 2 is integral with a load bar 3 that extends over the whole width of the curtain 1, between two U-shaped guiding rails 4 in which are placed the lateral ends of the curtain 1.

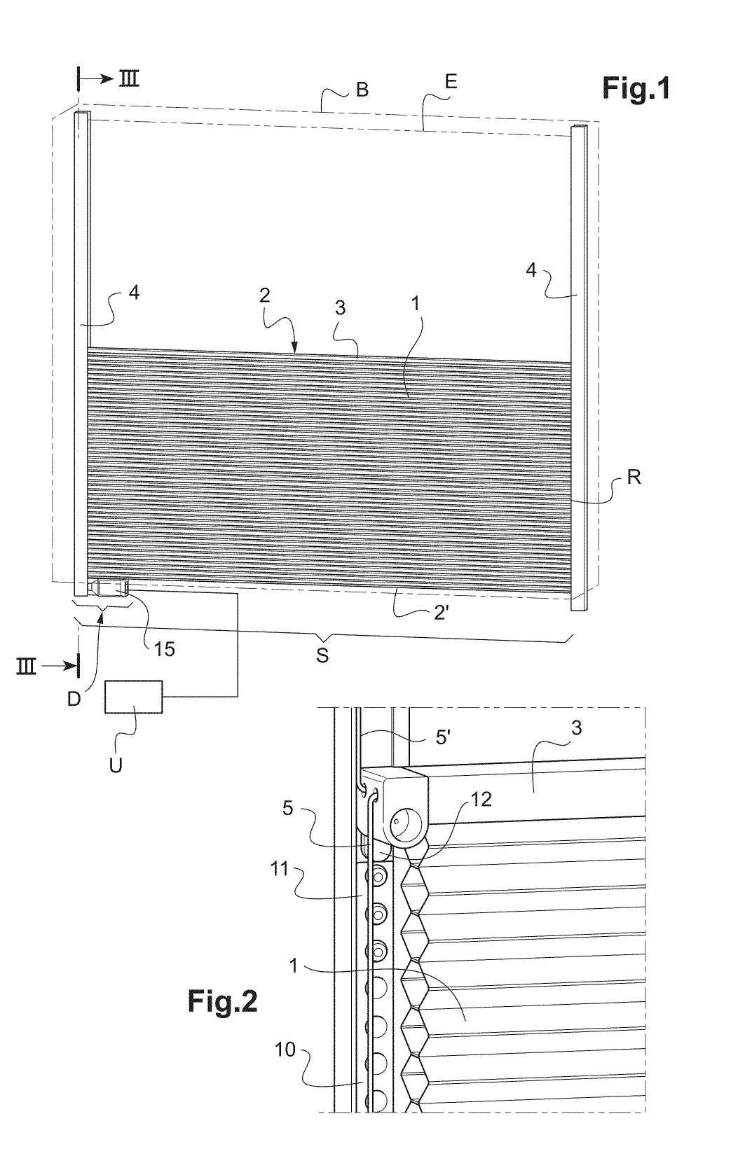

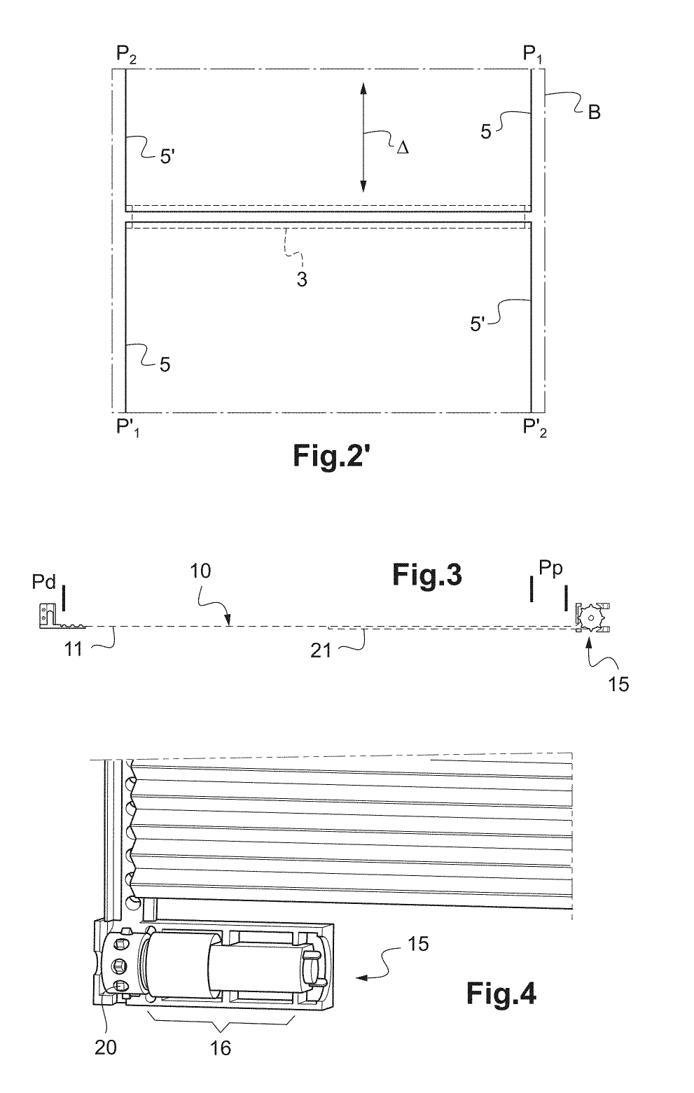

In order to guarantee the perpendicularity of the load bar 3 with respect to the guiding rails 4, a system of crossed cables 5 and 5′ is implemented, as shown in FIGS. 2 and 2′.

FIG. 2′ more particularly illustrates the principle of the system of crossed cables. As can be seen in this Figure, the ends of each cable 5, 5′ are fixed and rigidly fastened at two opposed points, respectively P1,P′ and P2, P2′, on a diagonal of the window B. Each cable 5, 5′ further passes inside the load bar 3, which can slide on the cables. Each cable 5, 5′ has then a length substantially equal to the sum of the length of the load bar 3 and of the distance separating the fixed points P1,P1′ and P2,P2′ of said cable, measured parallel to the direction of displacement Δ of the load bar 3. In addition to ensuring the guiding of the load bar, the crossed cables allow displacing the load bar by applying the operating force only to one of the ends thereof.

In order to ensure a motorized displacement of the mobile end 2, the invention proposes an operating device D that comprises, as shown in FIGS. 2 and 3, a flexible push belt 10, a first end 11 of which is connected to a carriage 12 integral with the load bar 3. According to the invention, the push belt 10 is not rigidly connected to the whole or the totality of the blind system, and more particularly, the push belt in not integrated to the curtain 1. Of course, it does not exclude a rigid connection between the first end 11 of the push belt 10 and the mobile end of the curtain 1 or the carriage 12. According the illustrated example, the load bar 3 is reversibly connected to the carriage 12 in order for their connection to be dismountable so as to allow a manual operation of the load bar 3 and hence of the blind system S, even in case of dysfunction of the motorized operating device D according to the invention. Moreover, between the push belt and the load bar is implemented a pivot connection of axis perpendicular to the plane of the push belt so as to reduce the transmission of twisting forces during the driving of the load bar.

The push belt 10 is adapted to transmit, to the mobile end 2 and more particularly to the carriage 12, either a pushing force so as to cause the extension of the curtain 1 up to the extended position E, or a traction force so as to cause the folding of the curtain 1 to the retraction position R. The push belt 10 must hence be rigid enough to allow the transmission of the forces necessary to the displacement of the mobile end while being flexible enough to allow a folding of the belt over itself as will be seen hereinafter, and that for a great number of cycles.

The push belt 10 must moreover not be too thick so as to be easily integrated in the space reserved to the blind system. For that purpose, the push belt 10 has a thickness lower than or equal to 3 mm, preferably lower than or equal to 0.5 mm, and more preferably lower than or equal to 0.2 mm.

In order to fulfil these mechanical and dimensional feature requirements, the push belt 10 is preferably made of polypropylene (PP).

The operating device D further comprises motorized means 15 for driving the push belt 10, adapted to translationally move the first end 11 between a proximal position Pp corresponding to the retraction position R of the curtain 1 and a distal position Pd corresponding to the extended position E of the curtain 1. The drive means 15 are piloted by a control unit U that may be made by any suitable manner and in particular comprise an interface for its integration to the electronics of a vehicle into which the operating device is intended to be integrated. The operating device may further comprise one or several sensors connected to the control unit U to allow a determination of the position of each mobile end of the blind system.

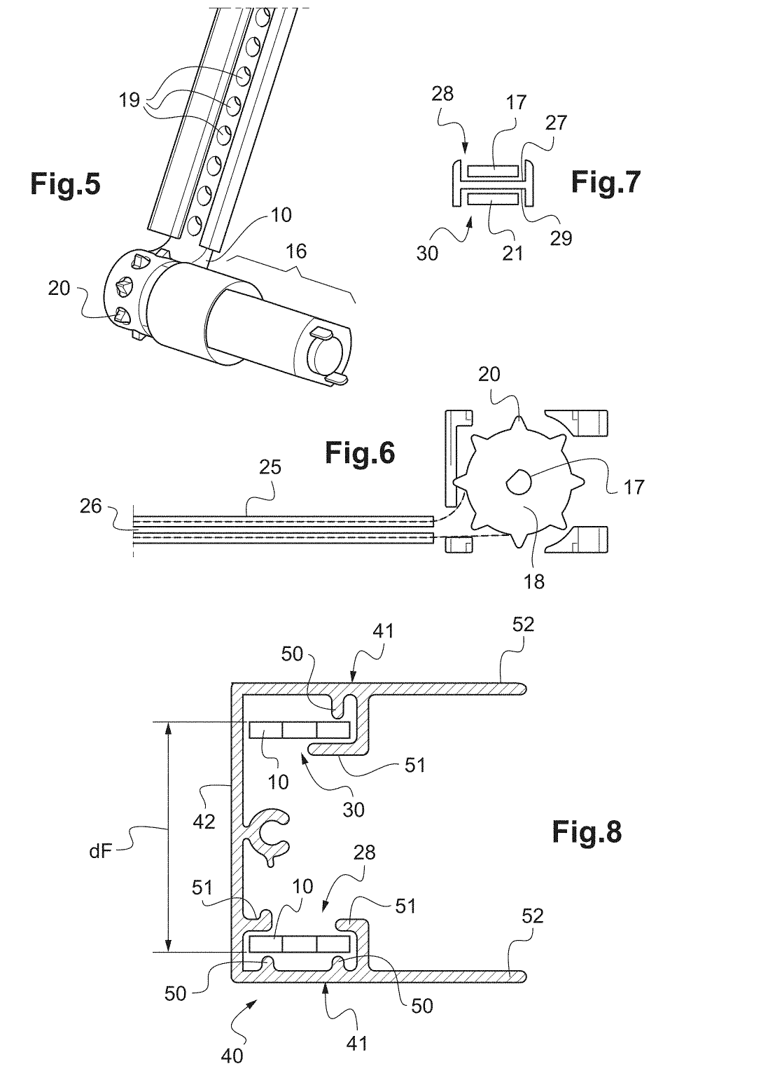

As can be seen in FIGS. 4 to 6, the drive means 15 comprise an electrical motor reducer 16 whose exit axis 17 is rotationally connected to a drive wheel 18 adapted to displace the push belt 10. According to the illustrated example, the push belt 10 is pierced so as to have perforations 19 distributed with a regular pitch. The drive wheel 18 has then teeth 20 intended to cooperate with the perforations 19 of the push belt 10 so as to limit the sliding of the latter with respect to the drive wheel 18.

The rigidity of the push belt 10 and the cooperation of the perforations with the teeth of the drive wheel allow the transmission of the significant forces, and that, despite the fineness or the small thickness of the push belt.

According to the invention, the drive wheel 18 also performs a function of steering wheel insofar as the second end 21 of the push belt 10 is herein transferred under the first end. It is to be noted that the push belt 10 then surrounds the drive and steering wheel 18 over an angular sector higher than 180° and more particularly comprised between 180° and 340°.

In order to avoid any interference between the two strands of the push belt 10 located upstream and downstream from the drive wheel 18, a guide 25, visible in FIGS. 6 and 7, having a median longitudinal wall 26, is implemented. A first face 27 of the median wall 26 delimits at least in part a first slide 28 in which the first end of the push belt circulates, whereas a face 29 opposite to the first face 27 delimits a second slide 30 in which the second end 21 circulates. Preferably and as shown in FIG. 7, the guide 25 has a H-shaped transverse cross-section.

The motor reducer 16 is moreover connected to a control unit U that allows a user to pilot the operation of said motor reducer to make it rotate in one direction or in the other according to the fact that the blind system has to be open or closed. It will be noted that the assembly comprising the operating device D and the blind system S form, within the meaning of the invention, an arrangement I for blinding the window E.

Within the framework of the example described in relation with FIGS. 1 to 7, the operating device according to the invention provides a transfer of the push belt 10 so that the two strands of the latter, located on either side of the drive and steering wheel 18 circulate along parallel and superimposed tracks. According to this example, the guide 25 defines the parallel and superimposed, or even juxtaposed, guiding slides or tracks.

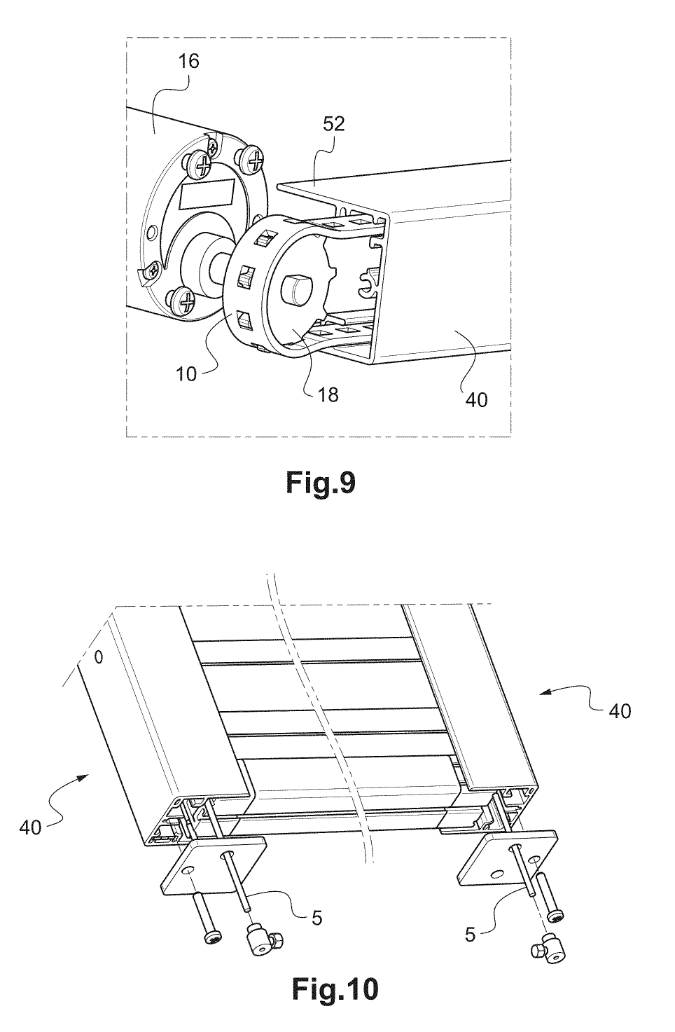

However, such an embodiment of the guide 25 is not strictly necessary. Hence, according to another embodiment of the invention more particularly illustrated in FIGS. 8 and 9, the guide 25 is formed by a profile 40 that carries and delimits at least in part the guiding tracks 28 and 30. According to this example, the profile 40 has a generally U-shape with two parallel legs 41 connected by a web 42. Each leg 41 delimits or forms a guiding track 28, 30 for one end or one strand of the push leg 10. In the present case, the guiding track 28 has a C-shaped cross-section, whereas the opposite guiding track 30 has a G-shaped cross-section. It is to be noted that the guiding tracks 28 and 30 each have at least one longitudinal rib 50 located opposite a return 51 partially closing the corresponding track so as to maintain the push belt 10. It must be observed that, according to this example, the legs 41 are each extended at the opposite of the web 42 by a wing 52. The two wings 52 then delimit a space in which can be located, for example and as shown in FIG. 10, the crossed cables 5 and 5′ for guiding the load bar, as well as the lateral ends of the blind system and of the load bar. The profile has hence several functions, including that of guiding the push belt, the load bar and the blind system.

In the case of implementation of such a profile, the distance df separating the bottom, herein defined by the ribs 50, from the opposite guiding tracks 28, 30 is preferably lower than or equal to the diameter of the drive wheel 18 measured at the ends of the teeth thereof.

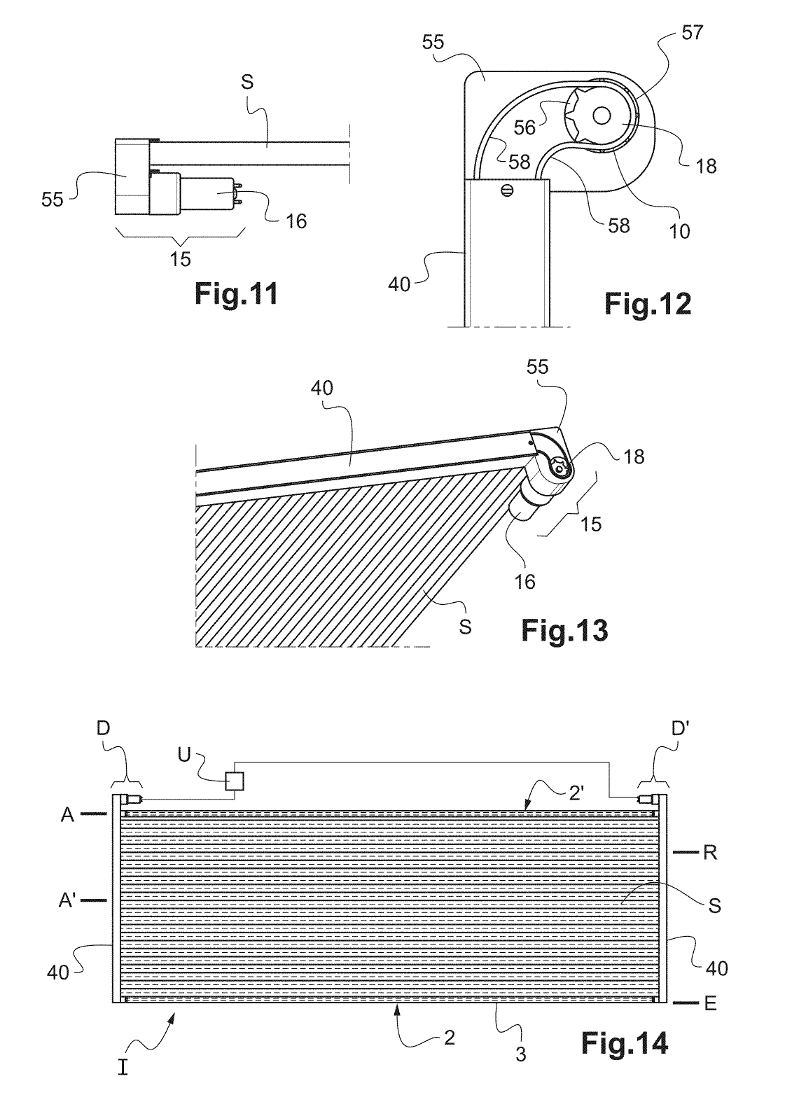

According to an embodiment more particularly illustrated in FIGS. 11 to 13, the operating device D and more particularly the drive means 15 comprise a casing 55 that surrounds the drive and steering wheel 18. The casing 55 delimits a drive chamber 56 inside which is located the drive wheel 18. The peripheral wall 57 of the chamber 56 then guides the push belt 10. According to the illustrated example, the casing 55 delimits, at the exit of the drive chamber 56, two portions of the guiding tracks 58, which are curved and which are connected to the rectilinear guiding track portions delimited by the profile 40, which is also rectilinear. The curved shape of the guiding track portions 58 delimited by the casing 55 allows reducing the size of the device measured parallel to the direction of translation of the blind system. Of course, according to another embodiment, the casing 55 may also have rectilinear guiding track portions.

According to the exemplary embodiment described in relation with FIGS. 1 to 7, the operating device comprises only one push belt located on one side of the curtain 1. However, it could be implemented more than one push belt and in particular two push belts located on either side of the curtain 1 and in the rails 4. The two push belts may then either be driven by common drive means, or be driven by distinct but synchronized drive means.

Still according to the exemplary embodiment described in relation with FIGS. 1 to 7, the blind system comprises only one mobile end. However, such an embodiment is not strictly necessary. Hence, FIG. 14 illustrates an embodiment of a blind arrangement I according to the invention whose blind system S comprises two ends 2 and 2′ mobile in translation. The first end 2 is mobile in translation between a retracted position R and an extended position E, whereas the second end is mobile in translation between a first position A and a second position A′.

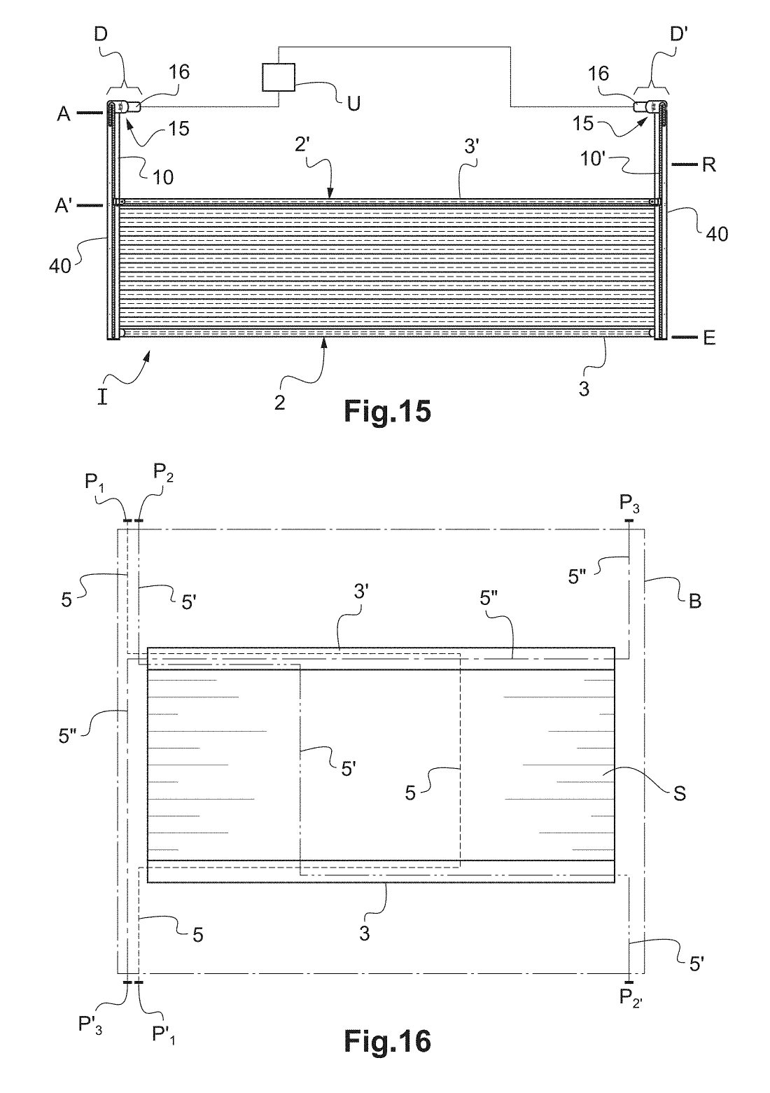

When the first end 2 is in the extended position R and the second end 2′ in the first position A, the window is then fully blinded, as shown in FIG. 14. When the second end 2 is in the extended position R and the second end 2′ in the second position A′, the window is then partially blinded in lower part, as shown in FIG. 15. This configuration may be qualified as privacy position insofar as the light passes through the top of the window but it is not possible to see through the lower part of the window. When the second end 2′ is in the first position A and the first end 2 in the retracted position R, the blind system S is in the lifted-up position and the window is maximally cleared.

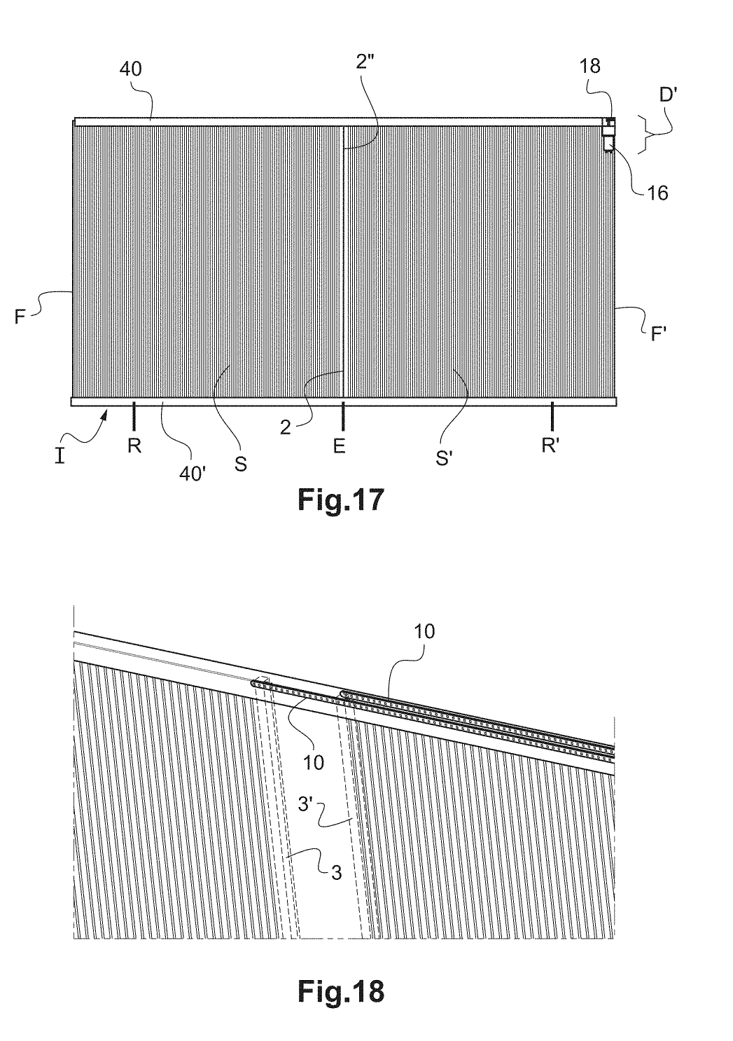

In the present case, the first mobile end 2 of the blind system S is connected to a first load bar 3 that extends between two guiding rails 40 and the second mobile end 2′ of the blind system S is connected to a second load bar 3′ that also extends between the two guiding rails 40. The blind arrangement I then comprises a system of crossed cables 5, 5′, 5″ adapted to guide the two load bars 3, 3′ during their displacement.

[55] As shown in FIG. 16, three cables 5, 5′, 5″ are implemented, the points of rigid fastening being respectively P1, P1′ for the cable 5, P2, P2′ for the cable 5′ and P3, P3′ for the cable 5″. The first cable 5 extends between the points P1 and P1′ located on a same side of the window B by circulating in the two load bars 3 and 3′. The second cable 5′ extends between the points P2 and P2′ located at the opposite relative to each other on a diagonal of the window B, by circulating in the two load bars 3 and 3′. The third cable 5 extends between the points P3 and P3′ located at the opposite relative to each other on a diagonal of the window B, by circulating in a single one of the two load bars, herein the second load bar 3′. Such a configuration of the crossed cable advantageously allows guiding two load bars with three cables and not four cables, as it is generally the case.

In order to allow a motorized operation of the two load bars 3 and 3′, the arrangement I comprises, on the one hand, a first operating device D, according to the invention, whose push belt 10 is connected to the first mobile end 2 by the first load bar 3 and, on the other hand, a second operating device D′, according to the invention, whose push belt 10′ is connected to the second mobile end 2′ of the second load bar 3′.

According to the examples described hereinabove, the blind arrangement comprises a single blind system or curtain S. However, the blind arrangement 1 according to the invention may comprise two blind systems S and S′, as shown in FIG. 17.

Hence, the arrangement I comprises a first blind system S, one end F of which is fixed, whereas the other end 2 is mobile in translation between a retracted position R and an extended position E in which the first system S blinds at least in part the window. The arrangement I also comprises a second blind system S′ comprising a fixed end F′ and an end 2″ mobile in translation between a retracted position R′ and the extended position E in which the second system S′ blinds at least in part the window.

The arrangement I also comprises an operating device D according to the invention, whose push belt 10 is connected to the mobile ends 2 and 2′ of the two blind systems, as shown in FIG. 18. Hence, a rotation in one direction of the drive and steering wheel 18 causes the mobile ends 2 and 2′ of the two blind systems S and S′ to get closer to each other, whereas a rotation in the reverse direction causes the mobile ends to get away from each other.

According to the example illustrated in FIGS. 17 and 18, the arrangement comprises, for each blind system S and S′, a load bar 3, 3′ that is integral with the corresponding mobile end 2, 2″. In the present case, the load bars 3 and 3′ are connected to the push belt 10 at the two opposite ends of the latter.

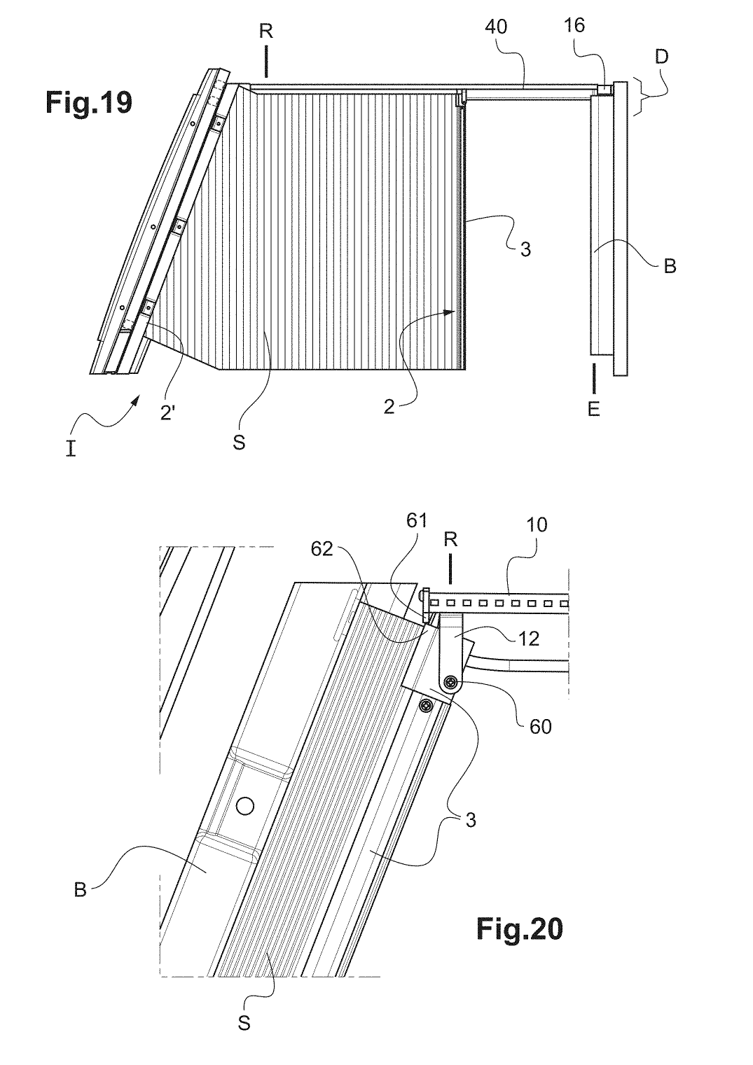

FIGS. 19 and 20 show an exemplary embodiment of an arrangement for blinding a window B of trapezoidal shape. According to this example, the blind system or curtain S comprises a fixed end that is connected to the inclined side of the window B. The opposite mobile end 2 of the blind system S is connected to a load bar 3 that is displaced by an operating device D according to the invention. The load bar is then mobile between the retracted position R illustrated in FIG. 10 and the extended position E.

According to this embodiment, the load bar 3 is connected to the carriage 12 integral with the push belt 10 through a pivot connection 60 of axis perpendicular to the plane of the push belt 10. In the present case, the axis of the pivot connection is substantially horizontal. Moreover, the axis 60 is located remote from the end of the load bar 3, as shown in FIG. 19. The arrangement I further comprises a stop 61 that defines the retracted position R and that is located upper than the pivot connection 60. Hence, when the load bar 3 is brought to the retracted position R by the push belt 10, its end 62 comes against the stop 61, which induces a rotation of the load bar 3 to make it parallel to the inclined side of the window.

Of course, various other variants or embodiments may be contemplated for the operating device and the arrangement according to the invention within the framework of the appended claims.

1. A device for operating a system for blinding a window, that comprises at least one end mobile in translation between a retracted position and an extended position in which the system blinds at least in part the window, the operating device comprising:
a flexible push belt that comprises a first and a second ends, which is intended to be connected to the mobile end of the blind system and which is adapted to transmit a pushing force to the mobile end of the blind system,
motorized means for driving the push belt, adapted to translationally move the push belt between a proximal position corresponding to the retracted position of the blind system and a distal position corresponding to the extended position of the blind system,
wherein it comprises two parallel tracks or slides, superimposed to each other or facing each other, in which the first and second ends of the push belt circulate, and in that the drive means comprise a drive and steering wheel around which the push belt is partially wound so that a portion of the push belt is located in the first slide and another portion is located in the second slide.

2. The device according to claim 1, wherein the push belt is perforated and in that the drive and steering wheel is provided with teeth, so that the teeth thereof mesh or cooperate with the perforations of the push belt so as to exert a pushing force to the latter.

3. The device according to claim 1, wherein it comprises a profile that carries and delimits at least in part the parallel guiding tracks facing each other.

4. The device according to claim 3, wherein the profile has a generally U-shape with two parallel legs connected by a web, each leg delimiting a guiding track for one end of the push belt.

5. The device according to claim 4, wherein it comprises at least one connection carriage between the push belt and the blind system and in that the carriage is located at least in part between the two parallel legs of the profile and moves between these latter.

6. The device according to claim 1, wherein the bottoms of the two guiding tracks facing each other are located at a distance lower than or equal to the diameter of the guiding and steering wheel.

7. The device according to claim 1, wherein the push belt surrounds the drive and steering wheel over an angular sector comprised between 170° and 340° and preferably comprised between 180° and 340°.

8. The device according to claim 4, wherein it comprises a casing that surrounds the drive and steering wheel and that delimits a drive chamber inside which is located the drive wheel and whose peripheral wall guides the push belt.

9. The device according to claim 8, wherein the profile is rectilinear and in that the casing delimits at the exit of the drive chamber two portions of the guiding tracks that are curved and connected to the guiding track portions delimited by the profile.

10. A window blind arrangement, comprising:
a window blinding system, that comprises at least one first end mobile in translation between a retracted position and an extended position in which the system blinds at least in part the window,
and a first operating device according to claim 1, whose push belt is connected to the first mobile end of the blind system.

11. An arrangement according to claim 10, wherein it comprises:
at least one first load bar that is integral with the first mobile end of the blind system, which is connected to the push belt of the first operating device and which extends between two guiding rails,
and a system of crossed cables adapted to guarantee the perpendicularity of the first load bar with respect to the guiding rails.

12. The arrangement according to claim 11, wherein the blind system comprises a second end mobile in translation between a first position and a second position, and in that it comprises a second operating device according to claim 11, whose push belt is connected to the second mobile end of the blind system.

13. The arrangement according to claim 12, wherein it comprises:
at least one second load bar that is integral with the second mobile end of the blind system, which is connected to the push belt of the second operating device and which extends between two guiding rails,
and a system of crossed cables adapted to guarantee the perpendicularity of the second load bar with respect to the guiding rails.

14. An arrangement according to claim 12, wherein it comprises a second blind system that comprises an end mobile in translation between a retracted position and an extended position in which the second system blinds at least in part the window, the mobile end of the second blind system being connected to the push belt of the first operating device so that a rotation in one direction of the drive and steering wheel causes the mobile ends of the two blind systems to get closer to each other and a rotation in the reverse direction causes the mobile ends to get away from each other.

15. The arrangement according to claim 14, wherein it comprises:
for each blind system, a load bar that is integral with the corresponding mobile end, which is connected to the push belt of the operating device and which extends between two guiding rails,
and a system of crossed cables adapted to guarantee the perpendicularity of the load bars with respect to the guiding rails

16. The device according to claim 2, wherein it comprises a profile that carries and delimits at least in part the parallel guiding tracks facing each other.

17. The device according to claim 2, wherein the bottoms of the two guiding tracks facing each other are located at a distance lower than or equal to the diameter of the guiding and steering wheel.

18. device according to claim 3, wherein the bottoms of the two guiding tracks facing each other are located at a distance lower than or equal to the diameter of the guiding and steering wheel.

19. device according to claim 4, wherein the bottoms of the two guiding tracks facing each other are located at a distance lower than or equal to the diameter of the guiding and steering wheel.

20. device according to claim 5, wherein the bottoms of the two guiding tracks facing each other are located at a distance lower than or equal to the diameter of the guiding and steering wheel.
